(19) United States
(12) Patent Application Publication
(10) Pub. No.: US 2026/0149389 A1
(43) Pub. Date: May 28, 2026

(54) Power Supply Device

(71) Applicant: VERTIV CORPORATION, Westerville, OH (US)

(72) Inventor: Zhongchang SUN, Shenzhen (CN)

(73) Assignee: VERTIV CORPORATION, Westerville, OH (US)

(21) Appl. No.: 19/374,785

(22) Filed: Oct. 30, 2025

(30) Foreign Application Priority Data
Nov. 22, 2024 (CN) 202422863779.1

(51) Int. Cl. H02M 7/23

(52) U.S. Cl. CPC H02M 7/23

(57) ABSTRACT

A power supply device includes at least one rectifier module, a DC bus and a controller. An input terminal of each rectifier module is connected to an AC power source, a first output terminal of each rectifier module is connected to a first terminal of the DC bus, a second output terminal of each rectifier module is connected to a second terminal of the DC bus, and an intermediate node of each rectifier module is connected to an intermediate node of the DC bus. The DC bus is configured to be connected to a load. The controller is connected to each rectifier module and is configured to control each rectifier module to rectify an electric energy of the AC power source and output the rectified electric energy of the AC power source to the DC bus.

### CROSS-REFERENCE TO RELATED APPLICATION

This application claims priority to Chinese Patent Application No. 202422863779.1, titled “POWER SUPPLY DEVICE”, filed on Nov. 22, 2024 with the China National Intellectual Property Administration, the entirety of which is incorporated herein by reference.

### FIELD

The present disclosure relates to the technical field of power electronics, and in particular to a power supply device.

### BACKGROUND

A three-wire high-voltage direct-current (DC) system is widely used in data centers, high-tech applications and other power supply scenarios due to its high efficiency and low loss. A rectifier in the three-wire high-voltage DC system converts alternating current (AC) power of an external AC power source into a bus voltage and supplies power to a rear-end apparatus via a DC bus having positive and negative buses. For a high-power power supply scenario, multiple rectifiers need to be arranged, and each of the rectifiers needs to be configured with at least two cables connected to the DC bus. Hence, a cable cost and transmission loss of the three-wire high-voltage DC system is increased.

### SUMMARY

An objective of the present disclosure is to provide a power supply device, with which a transmission loss and the number of cables of a DC system is reduced.

A power supply device is provided in the present disclosure. The power supply device may serve as a three-phase high-voltage DC system to power multiple devices powered by DC power. The power supply device may include at least one rectifier module, a DC bus and a controller.

An input terminal of each rectifier module is connected to an AC power source, a first output terminal of each rectifier module is connected to a first terminal of the DC bus, a second output terminal of each rectifier module is connected to a second terminal of the DC bus, and an intermediate node of each rectifier module is connected to an intermediate node of the DC bus. Each rectifier module includes multiple rectifiers connected in series, the first output terminal of each rectifier module refers to a high-level output terminal of the first rectifier among the multiple rectifiers in the rectifier module, and the second output terminal of each rectifier module refers to a low-level output terminal of the last rectifier among the multiple rectifiers in the rectifier module. The DC bus is configured to be connected to a load. The controller is connected to each rectifier module and is configured to control each rectifier module to rectify an electric energy of the AC power source and output the rectified electric energy of the AC power source to the DC bus.

With the above solution, when the rectifier module rectifies the electric energy of an external AC power source, each of the rectifiers connected in series may receive a part of the power for conversion, and only three cables are to be configured for the multiple serial-connected rectifiers for power transmission. Therefore, while achieving high-power power supply, a conversion efficiency can be improved, and the number of cables can be reduced.

In a possible design, the power supply device further includes an energy storage device and a voltage regulating circuit.

A first terminal of the voltage regulating circuit is connected to the DC bus, and a second terminal of the voltage regulating circuit is connected to the energy storage device, and the voltage regulating circuit is configured to convert a voltage of the DC bus into a charging voltage of the energy storage device and charge the energy storage device, or convert a voltage of the energy storage device into a rated voltage of the DC bus and power the DC bus. With the above design, the configured energy storage device may provide temporary power supply when an AC power source external to the power supply device fails, so that a power supply stability of the power supply device is improved.

In a possible design, the controller is connected to the voltage regulating circuit, and the controller is further configured to control the voltage regulating circuit to discharge the energy storage device when it is detected that a voltage of the AC power source is less than a first preset threshold, and control the voltage regulating circuit to charge the energy storage device when it is detected that the voltage of the AC power source is greater than the first preset threshold and a remaining capacity of the energy storage device is less than a second preset threshold.

In a possible design, the controller is further configured to control the voltage regulating circuit to discharge the energy storage device when it is detected that an output power of the rectifier module in the power supply device is less than a supply power of the load. With the above design, as a power demanded by the load connected at the rear end increases, resulting in that an output power of the rectifier module connected to the AC power cannot meet the power demand of the load, the energy storage device may be controlled to perform power compensation to ensure normal operation of the load.

In a possible design, the controller is further configured to: control the voltage regulating circuit to discharge the energy storage device when in a first time period, and control the voltage regulating circuit to charge the energy storage device when in a second time period. With the above design, the first time period may correspond to a peak power consumption period of a power grid, and the second time period may correspond to a low power consumption period of the power grid. The energy storage device may be controlled to supply power during the peak power supply period of the power grid, and the energy storage device may be charged during the low power consumption period of the power grid, which is conducive to alleviating a power supply pressure of the power grid.

In a possible design, the power supply device further includes a protection module, and the controller is connected to the protection module and is configured to control startup and shutdown of the protection module based on an operating electrical parameter of the power supply device.

In a possible design, the protection module includes an insulation protection circuit, the insulation protection circuit includes an insulation branch connected to each phase line of the DC bus, and the controller is further configured to: trigger a fault alarm when it is detected that a voltage of the intermediate node of the DC bus is greater than a third preset threshold.

In a possible design, the controller is further configured to: control a current of each rectifier module to be within a preset range in a case where the power supply device includes multiple rectifier modules. Due to device manufacturing or other reasons, when multiple rectifier modules operate in parallel, currents on the rectifier modules are not all the same, and currents on some rectifier modules may exceed a maximum allowable current, which may cause device failure. With the above design, the controller may control the current on each rectifier module to be the same or similar, so that each rectifier module receives the same power, avoiding overload of a single rectifier module.

In a possible design, the power supply device further includes a switch connected in series with each rectifier module, and the controller is further configured to: control the switch connected to a target rectifier module to be turned off, when it is determined that a current or voltage of the target rectifier module is greater than a fourth preset threshold. With the above design, when a single rectifier module fails, the switch connected to the failed rectifier module can be turned off to isolate the fault source and avoid expansion of the fault coverage.

In a possible design, the controller is further configured to receive a touch signal from a display panel and control an on/off state of each switch according to the touch signal.

### BRIEF DESCRIPTION OF THE DRAWINGS

For clearer illustration of the technical solutions according to embodiments of the present disclosure, hereinafter briefly described are the drawings to be applied in embodiments of the present disclosure. Apparently, the drawings in the following descriptions are only some embodiments of the present disclosure, and other drawings may be obtained by those skilled in the art based on the provided drawings without any creative effort.

FIG. 1 is a first schematic structural diagram of a power supply device according to an embodiment of the present disclosure;

FIG. 2 is a schematic structural diagram of a rectifier module according to an embodiment of the present disclosure;

FIG. 3 is a second schematic structural diagram of a power supply device according to an embodiment of the present disclosure; and

FIG. 4 is a schematic structural diagram of a monitoring system according to an embodiment of the present disclosure.

### DETAILED DESCRIPTION

Hereinafter, embodiments of the present disclosure are described in conjunction with the accompanying drawings.

Terms used in the embodiments of the present disclosure are only for explaining the specific embodiments of the present disclosure, and are not intended to limit the present disclosure. Apparently, the embodiments described below are only some embodiments, rather than all the embodiments of the present disclosure. Any other embodiments obtained by those skilled in the art based on the embodiments in the present disclosure without any creative effort shall fall within the protection scope of the present disclosure.

Some terms in the embodiments of the present disclosure are explained below to facilitate understanding by those skilled in the art.

(1) In the embodiments of the present disclosure, words “first”, “second”, and the like, are used to distinguish similar objects from each other, rather than to describe a specific sequence or order. It should be understood that data used in such manner may be interchanged appropriately, so that the embodiments of the present disclosure may be implemented in an order other than those illustrated or described herein.

(2) Term “a plurality of (multiple)” in the embodiments of the present disclosure refers to two or more than two, and other quantifiers are similar thereto.

(3) The “connection” in the embodiments of the present disclosure may be understood as an electrical connection or a communication connection. An electrical connection between two electrical elements may be a direct or indirect connection between the two electrical elements. For example, that A is connected to B may indicate that A is directly connected to B or that A is indirectly connected to B via one or more other electrical components. For example, that A is connected to B may be that A is directly connected to C and C is directly connected to B, so that A is connected to B via C. A communication connection between two electrical elements is a wireless connection between the two electrical elements, that is, the two electrical elements are electromagnetically connected to each other.

(4) The switching device in the embodiments of the present disclosure may be one or more of various types of switch tubes such as a relay, a metal oxide semiconductor field effect transistor (MOSFET), a bipolar junction transistor (BJT), an insulated gate bipolar transistor (IGBT), a silicon carbide (SiC) transistor, and a silicon-controlled rectifier (SCR), which are not listed one by one in the embodiments of the present disclosure. A packaging form of each switch tube may be a single-tube packaging or a multi-tube packaging, which is not limited in the embodiments of the present disclosure. Each switch tube may include a first terminal, a second terminal and a control terminal. The control terminal may control the switch tube to be turned on or off according to a received PWM signal. When the switch tube is turned on, a current may be transmitted between the first terminal and the second terminal of the switch tube. When the switch tube is turned off, no current is transmitted between the first terminal and the second terminal of the switch tube. Taking a MOSFET as an example, the control terminal of the switch tube serves as a gate. The first terminal of the switch tube may serve as a source, and the second terminal may serve as a drain. Alternatively. The first terminal may serve as the drain, and the second terminal may serve as the source.

An application scenario of a power supply device in the embodiments of the present disclosure is described in detail below with reference to the accompanying drawings. The power supply device provided in the embodiments of the present disclosure is applicable to a DC power supply scenario, that is, the power supply device may supply power to multiple electrical apparatuses powered by DC power, and may supply power to multiple electrical apparatuses powered by AC power via an inverter.

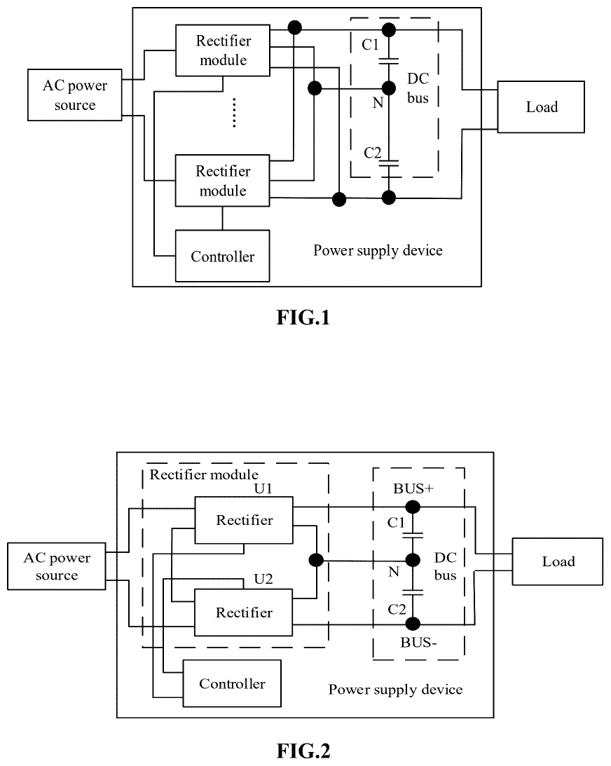

Reference is made to FIG. 1, which is a schematic structural diagram of a power supply device according to an embodiment of the present disclosure. As shown in FIG. 1, the power supply device includes at least one rectifier module, a DC bus and a controller.

It should be understood that the power supply device shown in FIG. 1 is only an example, and the power supply device may have more components than those shown in FIG. 1. For example, the power supply device may be further configured to control a relay connected to an AC power source or a relay connected to a load. When the power supply device fails or an external AC power source fails, the relay may be controlled to be disconnected, thereby cutting off the fault source and avoiding expansion of the fault coverage. The components shown in FIG. 1 may be implemented in hardware, software, or a combination of hardware and software, including one or more signal processing and/or dedicated integrated circuits.

Specifically, an input terminal of each rectifier module is connected to an AC power source, a first output terminal of each rectifier module is connected to a first terminal of the DC bus, a second output terminal of each rectifier module is connected to a second terminal of the DC bus, and an intermediate node of each rectifier module is connected to an intermediate node of the DC bus. The DC bus is configured to be connected to a load. The controller is connected to each rectifier module and is configured to control each rectifier module to rectify an electric energy of the AC power source and output the rectified electric energy of the AC power source to the DC bus. Each rectifier module includes multiple rectifiers connected in series, the first output terminal of each rectifier module refers to a high-level output terminal of the first rectifier among the multiple rectifiers in the rectifier module, and the second output terminal of each rectifier module refers to a low-level output terminal of the last rectifier among the multiple rectifiers in the rectifier module.

It should be noted that FIG. 1 illustrates an example where the power supply device is configured with multiple rectifier modules, and the DC bus is formed by a bus capacitor C1 and a bus capacitor C2. In an actual application, there may be only one rectifier module configured in the power supply device, which is not specifically limited in the present disclosure.

With the power supply device provided in the embodiment of the present disclosure, one or more rectifier modules are configured in the power supply device, and each rectifier module is connected between an external AC power source and a DC bus having positive and negative buses. Each rectifier module includes multiple rectifiers connected in series. When each rectifier module operates, each rectifier in the rectifier module may receive a part of the power outputted by the AC power source, and rectify and output the received part of the power. Since the rectifiers in the rectifier module are connected in series, a conversion power of the single rectifier module is equal to a sum of conversion powers of the multiple rectifiers in the rectifier module, and only three cables connected to the DC bus need to be provided for the multiple rectifiers in the single rectifier module for power transmission. In this way, while achieving high-power power supply, the number of internal cables in the power supply device can be reduced, which is beneficial for reducing a cable cost and reducing a power transmission loss.

In an actual application, the power supply device may be configured with a casing. The rectifier module, the DC bus and the controller are all inside the casing. The casing is provided with an external interface for being connected to an AC power source and an external interface for being connected to a load. The AC power source and the load may be connected to the power supply device via the corresponding external interfaces.

In a case where the power supply device provided in the embodiment of the present disclosure is configured to supply power to a load, multiple electrical apparatuses powered by DC power may be directly connected to the DC bus and obtain electric energy required for operation from the DC bus. Multiple electrical apparatuses powered by AC power may be connected to the DC bus via an inverter. The inverter may convert a voltage on the DC bus into an AC power, to power the multiple electrical apparatuses connected at the rear end.

In an actual application, the multiple rectifiers in each rectifier module are connected in series, and an intermediate node of the multiple serial-connected rectifiers is connected to an intermediate node of the DC bus. For example, the DC bus includes a +400V positive bus, a −400V negative bus and a neutral line N, then half of the rectifiers connected between the first output terminal and the intermediate node in the rectifier module power the positive bus, and half of the rectifiers connected between the intermediate node and the second output terminal in the rectifier module power the negative bus.

It should be noted that the rectifier may be implemented in a circuit topology commonly used in the industry with the above-mentioned function, such as an H-bridge rectifier circuit and a Vienna circuit. Apparently, the rectifier may be implemented using an integrated chip and a peripheral circuit, which is not limited in the present disclosure.

Reference is made to FIG. 2, which is a schematic structural diagram of a power supply device in a case where a single rectifier module includes two rectifiers connected in series. As shown in FIG. 2, the rectifier module includes a rectifier U1 and a rectifier U2 which are connected in series. A first output terminal of the rectifier U1 is connected to a positive bus BUS+, a second output terminal of the rectifier U1 is connected to a neutral line N, a first output terminal of the rectifier U2 is connected to a negative bus BUS−, and a second output terminal of the rectifier U2 is connected to the neutral line N.

In a case where the rectifier module structure as shown in FIG. 2 is applied to power the DC bus, since the input terminals of the rectifier U1 and the rectifier U2 are connected in series, if the rectifier U1 and the rectifier U2 have the same device model and driving signal, under an ideal condition, the voltages received by the rectifier U1 and the rectifier U2 are equal to half of the output of the AC power source, that is, each of the rectifier U1 and the rectifier U2 receives and converts half of the power of the AC power source, the rectifier U1 supplies the processed electric energy to power the positive bus BUS+ connected at the rear end, and the rectifier U2 supplies the processed electric energy to power the negative bus BUS− connected at the area end.

It should be noted that the rectifier module shown in FIG. 2 is only an example. In actual applications, each rectifier module may include more than two rectifiers. For example, a single rectifier module may include six rectifiers connected in series, which is not limited in the present disclosure.

In actual application, a rectifier in the rectifier module is generally formed by a switch tube and an energy storage inductor. Operation of the rectifiers may be controlled by on/off of the switch tube. A controller of the switch tube may be connected to the controller in the power supply device. The controller may control the on/off of the switch tube by sending a driving signal of a corresponding level to the connected switching device, thereby controlling the operation of the rectifier.

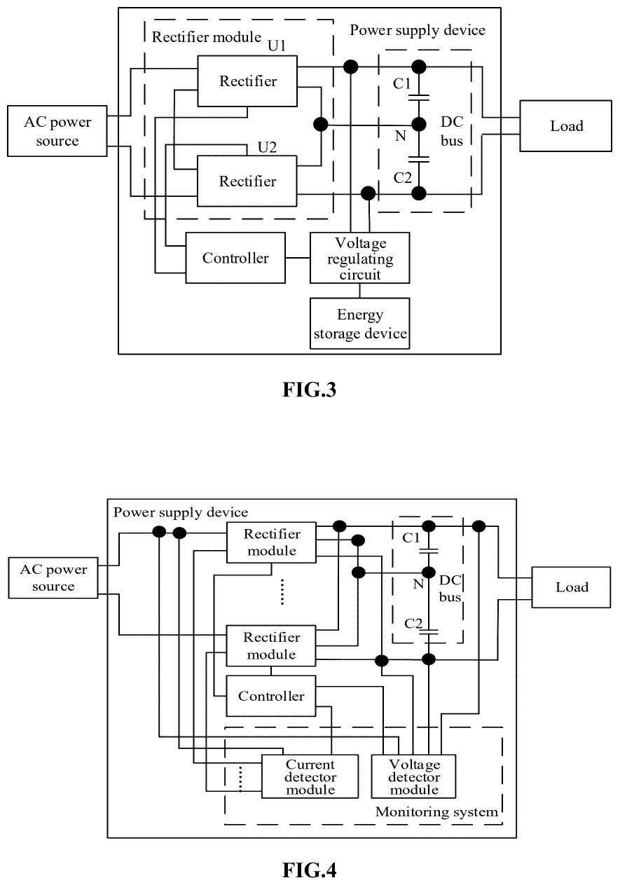

In some embodiments, since the power supply source of the DC bus is an external AC power source, when the AC power source fails, the power supply device cannot supply power to the load connected at the rear end. In order to improve a power supply stability of the power supply device, as shown in FIG. 3, the power supply device further includes an energy storage device and a voltage regulating circuit connected between the energy storage device and the DC bus.

A first terminal of the voltage regulating circuit is connected to the DC bus, and a second terminal of the voltage regulating circuit is connected to the energy storage device. The voltage regulating circuit may be a bidirectional power transmission device, and performs a charging operation or discharging operation for the energy storage device. In a case where the voltage regulating circuit performs a charging operation for the energy storage device, the voltage regulating circuit may convert a voltage of the DC bus into a charging voltage of the energy storage device and charge the energy storage device. In a case where the voltage regulating circuit performs a discharging operation for the energy storage device, the voltage regulating circuit converts a voltage of the energy storage device into a rated voltage of the DC bus and powers the DC bus.

In an actual application, the voltage regulating circuit may charge the energy storage device with part of electric energy of the AC power source in a case where the external AC power source is normal, and power the DC bus with the electric energy stored in the energy storage device in a case where the AC power source fails, until the fault of the AC power source is eliminated. In this way, the power supply stability of the power supply device is improved. Operation of the voltage regulating circuit may be controlled by the controller. The controller may control the voltage regulating circuit to discharge the energy storage device when it is detected that a voltage of the AC power source is less than a first preset threshold, and control the voltage regulating circuit to charge the energy storage device when it is detected that the voltage of the AC power source is greater than the first preset threshold and a remaining capacity of the energy storage device is less than a second preset threshold. The first preset threshold may be set based on a normal working range of the AC power source. For example, the normal working range of the AC power source is [370V, 390V], and the first preset threshold may be set to 360V. Apparently, the first preset threshold may be set to other values, which is not limited in the present disclosure.

In some embodiments, the controller may further detect a supply power of the load. In a case where it is detected that an output power of the rectifier module in the power supply device is less than the supply power of the load, it is determined that the output power of the AC power source cannot meet the power supply demand of the load. In order to ensure the normal operation of the load, the voltage regulating circuit may be controlled to discharge the energy storage device so as to meet the power supply demand of the load.

In an embodiment, the external power source connected to the power supply device is generally a power grid, and the power grid is connected to multiple electrical apparatuses to be powered. When the electrical apparatuses are in a peak power consumption period, if the power supply device continues obtaining electric energy from the power grid, the grid voltage may fluctuate, affecting the normal operation of the power grid. In order to alleviate a power supply pressure of the power grid, the controller may control the voltage regulating circuit to discharge the energy storage device when in a first time period, and control the voltage regulating circuit to charge the energy storage device when in a second time period.

The first time period and the second time period refer to a peak power consumption period and a low power consumption period of the power grid, respectively. The first time period and the second time period may be determined through an instruction issued by the power grid, or may be determined by detecting an electrical parameter on the power grid. This is not limited in the present disclosure here.

Described above is a situation where the power supply device is configured with one rectifier module. In a case where a conversion power of the single rectifier module cannot meet the power demand, multiple rectifier modules may be configured in the power supply device. The multiple rectifier modules are connected in parallel. In an actual application, due to reasons such as production and manufacturing, the current amplitudes on the rectifier module are different, which may cause the currents on some of the rectifier modules to exceed a normal operating current. In order to ensure the normal operation of the power supply device, the power supply device may adjust the current value on each rectifier module by controlling a conduction timing of switch tubes in the rectifier module and configuring a rheostat, to cause the current of each rectifier module to be within a preset range.

It should be noted that configuring a rheostat or adjusting the conduction timing of the switch tubes is only one of the methods to balance the current among multiple rectifier modules. Other methods may be applied in the present disclosure to achieve current balance among multiple rectifier modules, which are not introduced in detail here.

In some embodiments, since the multiple rectifiers in a rectifier module are connected in series, the rectifier module cannot work if one of the rectifiers in the rectifier module fails. In a case where the power supply device is configured with multiple rectifier modules which are connected in parallel, switches may be configured for the rectifier modules correspondingly, so as to allow other rectifier modules to normally power the DC bus. Each rectifier module may be connected in series with a corresponding switch. When a faulty target rectifier module is detected, the controller may control the switch connected to the target rectifier module to be turned off, so that the faulty rectifier module is electrically disconnected from the normal rectifier modules, avoiding expansion of the fault coverage.

In an actual application, a fault state of a rectifier module may be determined by detecting an electrical parameter during the operation of each rectifier module. For example, a rectifier module may be determined as the faulty target rectifier module on detecting that a current of the rectifier module is greater than a fourth preset threshold. The fourth preset threshold may be set based on a maximum value of a current allowed to pass through the rectifier module during rectification. For example, the maximum current allowed in a normal operation of the rectifier module is 50 A, and then the fourth preset threshold may be set to 51 A.

Specifically, faults of the rectifier module include but are not limited to: overcurrent fault, short circuit fault and overvoltage fault. Generally, the power supply device is equipped with a monitoring system. The monitoring system may be connected to multiple detection devices for detecting an operating state of each rectifier module. For example, the monitoring system is configured with a voltage detector and a current detector connected to each rectifier module. The voltage detector and current detector may detect a voltage and current of each rectifier module, and feedback the detected current value and voltage value to the controller. On detecting that the current value or the voltage value of the rectifier exceeds a corresponding normal working range, the controller may determine that the rectifier module has a fault and control a switch connected to the rectifier module to be turned off. Thereby, the faulty rectifier module is disconnected from the main circuit and the other normal rectifier modules, realizing isolation of the fault source and avoiding further expansion of the fault coverage. The normal working range corresponding to the current value and the voltage value may be set based on a connection scenario of the power supply device and an internal configuration of the rectifier module, which is not described in detail here.

In an example, when the load connected at the rear end is reduced, the output power of the power supply device is greater than a power required by the load. In this case, if the rectifier modules are all controlled to operate to supply power to the load connected at the rear end of the DC bus, a waste of electric energy may be caused. In order to avoid waste of electric energy, an operator may shut down some rectifier module(s) by touching a display screen. On reception of a touch signal for operation of the rectifier modules, the controller may control a corresponding switch to disconnect so as to control some rectifier module(s) to stop working.

In an actual application, in addition to the above-mentioned fault protection of the rectifier module, the controller can perform other protections to achieve safety protection of the main circuit.

In an example, the monitoring system further includes a current detector, a leakage detector and a voltage detector configured for the main circuit. The power supply device is further configured with a switching device connected to the AC power source and a switching device connected to the load. On detecting that a current value and a voltage value on the main circuit exceed a corresponding normal working range, the controller may control the switching device connected to the AC power source and the switching device connected to the load to ensure safety of other devices connected to a faulty device.

Reference is made to FIG. 4, which is a schematic structural diagram of a monitoring system. A current detector module includes a first current detector for detecting a current of the main circuit and a second current detector corresponding to a rectifier module. Each second current detector detects a current on a corresponding rectifier module. A voltage detector module includes a first voltage detector for detecting a voltage of the main circuit and a group of second voltage detectors corresponding to phase lines of the DC bus in a one-to-one correspondence. Each second voltage detector detects a voltage on a corresponding rectifier module. The current detector module and the voltage detector module transmit detected values to the controller for fault diagnosis.

In actual applications, the power supply device is generally configured with a cabinet, multiple devices in the power supply device are arranged inside the cabinet, and the cabinet is provided with a power interface for being connected to an AC power source and a load interface for being connected to a load. When the power supply device needs an insulation test, a terminal of a leakage current detector may be connected to the power interface of the cabinet, and another terminal of the leakage current detector is grounded, performing leakage current protection for the cabinet.

It should be noted that the monitoring system structure shown in FIG. 4 is only an example. In actual applications, the number of detectors in the current detector module and the voltage detector module and positions of the detectors may be configured based on positions and the number of detection points in the power supply device. In addition, the leakage detector performs leakage detection on the power supply device by detecting a leakage current of the cabinet. The leakage detection may be performed by other leakage detection methods commonly used in the industry, and a type of the leakage detector and an installation position of the leakage detector may be configured based on a leakage detection method. This is not limited in the present disclosure.

In an example, the power supply device is further provided with an insulation branch connected to each phase line of the DC bus, and the controller is further configured to trigger a fault alarm when it is detected that a voltage of the intermediate node of the DC bus is greater than a third preset threshold, to prompt an operator for repair.

Apparently, various modifications and variations to the embodiments of the present disclosure can be made by those skilled in the art without departing from the spirit and scope of the present disclosure. Hence, as the modifications and variations of the present disclosure fall within the scope of the claims of the present disclosure and equivalents thereof, the present disclosure is also intended to include such modifications and variations.

What is claimed is:

1. A power supply device, comprising at least one rectifier module, a DC bus and a controller, wherein
an input terminal of each rectifier module is connected to an AC power source, a first output terminal of each rectifier module is connected to a first terminal of the DC bus, a second output terminal of each rectifier module is connected to a second terminal of the DC bus, and an intermediate node of each rectifier module is connected to an intermediate node of the DC bus, wherein each rectifier module comprises a plurality of rectifiers connected in series, the first output terminal of each rectifier module refers to a high-level output terminal of the first rectifier among the plurality of rectifiers in the rectifier module, and the second output terminal of each rectifier module refers to a low-level output terminal of the last rectifier among the plurality of rectifiers in the rectifier module;
the DC bus is configured to be connected to a load; and
the controller is connected to each rectifier module and is configured to control each rectifier module to rectify an electric energy of the AC power source and output the rectified electric energy of the AC power source to the DC bus.

2. The power supply device according to claim 1, further comprising an energy storage device and a voltage regulating circuit, wherein
a first terminal of the voltage regulating circuit is connected to the DC bus, and a second terminal of the voltage regulating circuit is connected to the energy storage device, and the voltage regulating circuit is configured to convert a voltage of the DC bus into a charging voltage of the energy storage device and charge the energy storage device, or convert a voltage of the energy storage device into a rated voltage of the DC bus and power the DC bus.

3. The power supply device according to claim 2, wherein the controller is connected to the voltage regulating circuit, and the controller is further configured to control the voltage regulating circuit to discharge the energy storage device when it is detected that a voltage of the AC power source is less than a first preset threshold, and control the voltage regulating circuit to charge the energy storage device when it is detected that the voltage of the AC power source is greater than the first preset threshold and a remaining capacity of the energy storage device is less than a second preset threshold.

4. The power supply device according to claim 2, wherein the controller is further configured to control the voltage regulating circuit to discharge the energy storage device when it is detected that an output power of the rectifier module in the power supply device is less than a supply power of the load.

5. The power supply device according to claim 2, wherein the controller is further configured to: control the voltage regulating circuit to discharge the energy storage device when in a first time period, and control the voltage regulating circuit to charge the energy storage device when in a second time period.

6. The power supply device according to claim 1, further comprising a protection module, wherein the controller is connected to the protection module and is configured to control startup and shutdown of the protection module based on an operating electrical parameter of the power supply device.

7. The power supply device according to claim 2, further comprising a protection module, wherein the controller is connected to the protection module and is configured to control startup and shutdown of the protection module based on an operating electrical parameter of the power supply device.

8. The power supply device according to claim 6, wherein the protection module comprises an insulation protection circuit, the insulation protection circuit comprises an insulation branch connected to each phase line of the DC bus, and the controller is further configured to trigger a fault alarm when it is detected that a voltage of the intermediate node of the DC bus is greater than a third preset threshold.

9. The power supply device according to claim 7, wherein the protection module comprises an insulation protection circuit, the insulation protection circuit comprises an insulation branch connected to each phase line of the DC bus, and the controller is further configured to trigger a fault alarm when it is detected that a voltage of the intermediate node of the DC bus is greater than a third preset threshold.

10. The power supply device according to claim 1, wherein the controller is further configured to: control a current of each rectifier module to be within a preset range in a case where the power supply device comprises a plurality of rectifier modules.

11. The power supply device according to claim 1, further comprising switches respectively connected in series with each rectifier module, wherein the controller is further configured to: control the switch connected to a target rectifier module to be turned off, when it is determined that a current or voltage of the target rectifier module is greater than a fourth preset threshold.

12. The power supply device according to claim 11, wherein the controller is further configured to receive a touch signal from a display panel and control an on/off state of each switch according to the touch signal.
